(19) United States
(12) Patent Application Publication
(10) Pub. No.: US 2018/0287866 A1
(43) Pub. Date: Oct. 4, 2018

(54) METHOD AND APPARATUS FOR CONFIGURING RELAY BETWEEN UE AND NETWORK IN DEVICE-TO-DEVICE COMMUNICATION

(71) Applicant: Jungkil NAM, Seongnam-si, Gyeonggi-do (KR)

(72) Inventor: Sung Jun YOON, Seoul (KR)

(73) Assignee: Jungkil NAM, Seongnam-si, Gyeonggi-do (KR)

(21) Appl. No.: 15/573,644

(22) PCT Filed: May 13, 2016
(86) PCT No.: PCT/KR2016/005063

§ 371 Date: Mar. 23, 2018

(30) Foreign Application Priority Data
May 15, 2015 (KR) 10-2015-0068317

(51) Int. Cl. H04L 12/24; H04B 7/155; H04B 17/318; H04W 56/00; H04L 5/00

(52) U.S. Cl. CPC H04L 41/0806; H04B 7/155; H04W 88/04; H04W 56/001; H04L 5/0048; H04B 17/318

(57) ABSTRACT

A method for configuring a relay between a UE and a network in device-to-device communication, including: selecting one or more UEs, which support the D2D communication within network coverage of a base station, as relay UEs; allocating and transmitting a unique number to the UEs selected as the relay UEs; by the relay UE, determining physical layer sidelink synchronization identity (PSSID) based on the received unique number; by the relay UE, generating a physical sidelink broadcast channel (PSBCH) and a demodulation reference signal (DM-RS) associated with the PSBCH based on the PSSID; by the relay UE, transmitting the generated PSBCH and DM-RS associated with the PSBCH to a remote UE for performing communication with the base station beyond the network coverage; and by the remote UE, selecting a UE, with which the remote UE itself will communicate, among the relay UEs.

### BACKGROUND

The present disclosure relates to wireless communication, and more particularly to a method and apparatus for configuring a relay between a user equipment (UE) and a network in device-to-device (D2D) communication.

D2D communication refers to communication for direct data exchange between two adjacent UEs without using a base station. That is, two UEs respectively serve as a source and a destination of data to perform communication.

The D2D communication may be implemented by a communication method using an unlicensed bandwidth, such as Bluetooth, wireless local area network (WLAN) communication implemented by the Institute of Electrical and Electronics Engineers (IEEE) 802.11 and the like, etc., but it is difficult for such a communication method using the unlicensed bandwidth to provide a planned and controlled service. In particular, performance may be drastically reduced by interference.

Therefore, there is a need for D2D communication measures to efficiently use a frequency for providing service and improve performance in consideration of interference.

### SUMMARY

A technical aspect of the present disclosure is to provide a method and apparatus for efficiently selecting a relay UE so that a UE outside network coverage for D2D communication can communicate with a base station in a wireless communication system.

Another technical aspect of the present disclosure is to provide an apparatus and method for configuring a relay UE so that a UE outside network coverage can communicate with a base station in a wireless communication system supporting D2D communication.

According to one aspect of the present disclosure, there is provided a method of configuring a relay between a user equipment (UE) and a network in device-to-device (D2D) communication. The method includes: selecting one or more UEs, which support the D2D communication within network coverage of a base station, as relay UEs; allocating and transmitting a unique number to the UEs selected as the relay UEs; by the relay UE, determining a physical layer sidelink synchronization identity (PSSID) based on the received unique number; by the relay UE, generating a physical sidelink broadcast channel (PSBCH) and a demodulation reference signal (DM-RS) associated with the PSBCH based on the PSSID; by the relay UE, transmitting the generated PSBCH and DM-RS associated with the PSBCH to a remote UE for performing communication with the base station beyond the network coverage; and by the remote UE, selecting a UE, with which the remote UE itself will communicate, among the relay UEs.

According to another aspect of the present disclosure, there is provided a network system for configuring a relay between a user equipment (UE) and a network in device-to-device (D2D) communication. The network system includes: a base station configured to select one or more UEs, which support the D2D communication within network coverage of a base station, as relay UEs, and allocate and transmit a unique number to the UEs selected as the relay UEs; the relay UE configured to determine a physical layer sidelink synchronization identity (PSSID) based on the received unique number, generate a physical sidelink broadcast channel (PSBCH) and a demodulation reference signal (DM-RS) associated with the PSBCH based on the PSSID, and transmit the generated PSBCH and DM-RS associated with the PSBCH to a remote UE for performing communication with the base station beyond the network coverage; and the remote UE configured to select a UE, with which the remote UE itself will communicate, based on the PSBCH and the DM-RS associated with the PSBCH received from the relay UE.

According to the present disclosure, a relay UE is efficiently selected and configured for connection between a UE outside network coverage and a base station in D2D communication.

### BRIEF DESCRIPTION OF THE DRAWINGS

FIG. 1 is a block diagram of a wireless communication system to which the present disclosure is applied.

FIG. 2 is a view for explaining concept of the D2D communication to which the present disclosure is applied.

FIG. 3 and FIG. 4 schematically illustrate structures of a radio frame to which the present disclosure is applied.

FIG. 5 is a view for explaining a method of expanding network coverage through a relay UE in cellular network-based D2D communication.

FIG. 6 is a view for explaining a wireless protocol defined in the present disclosure.

FIG. 7 is a view for explaining a method of selecting the relay UE in the cellular network-based D2D communication according to the present disclosure.

FIG. 8 illustrates a flow of the method of selecting a relay UE to communicate with a remote UE according to one embodiment of the present disclosure.

FIG. 9 illustrates a flow of the method of selecting a relay UE to communicate with a remote UE according to another embodiment of the present disclosure.

FIG. 10 is a block diagram of a wireless communication system according to one embodiment of the present disclosure.

### DETAILED DESCRIPTION

Hereinafter, exemplary embodiments of the present disclosure will be described in detail with reference to the accompanying drawings. In terms of giving reference numerals to elements in each of the drawings, like numerals refer to like elements if possible even though they are illustrated in different drawings. Further, detailed descriptions of well-known features or functions related to the description of the embodiments according to the present disclosure will be omitted if it is determined that they may obscure the gist of the present disclosure.

In the present disclosure, description will be aimed at a communication network, and tasks in the communication network may be performed while controlling a network and transmitting data in a system (e.g. a base station) for taking charge of the communication network or may be performed in user equipment (UE) linked to the network.

Further, in the present disclosure, a system is provided for efficiently operating device-to-device (D2D) communication that supports intercommunication within the network, and the D2D communication operated and provided under the system may increase a communication coverage distance.

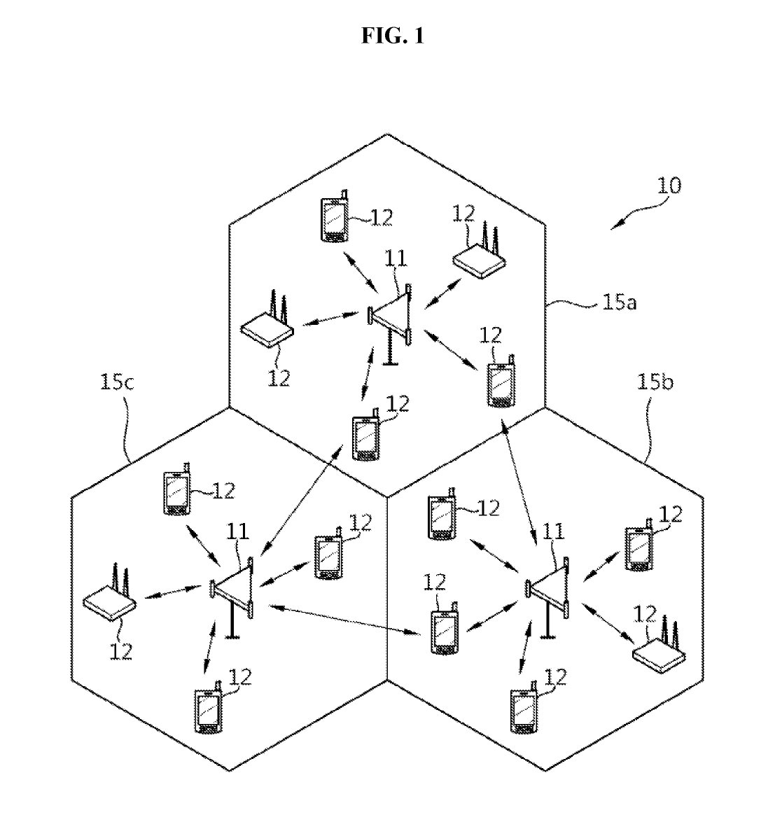

FIG. 1 is a block diagram of a wireless communication system to which the present disclosure is applied.

Referring to FIG. 1, a wireless communication system 10 is widely arranged to provide a variety of communication services for audio, packet data, etc. The wireless communication system 10 includes at least one base station (BS) 11. Each base station 11 provides communication service with regard to a specific geographical domain or frequency domain, which will be called a site. The site may be divided into a plurality of areas 15a, 15b, 15c, which will be called sectors, and the sectors may have cell IDs different from one another.

A UE 12 may be stationary or movable, and may be also variously called a mobile station (MS), a mobile terminal (MT), a user terminal (UT), a subscriber station (SS), a wireless device, a personal digital assistant (PDA), a wireless modem, a handheld device, etc. The base station 11 generally refers to a station for communicating with the UE 12, and may be also variously called an evolved-NodeB (eNodeB), a base transceiver system (BTS), an access point (AP), a femto base station (or femto eNodeB), a home base station (or home eNodeB (HeNodeB)), a relay, a remote radio head (RRH), etc. The cells 15a, 15b, and 15c should be construed in generic sense to denote a partial area covered by a base station 11, and include various coverage areas such as mega cells, macro cells, micro cells, pico cells, femto cells, etc.

Hereinafter, downlink refers to communication or a communication path from the base station 11 toward the UE 12, and uplink refers to communication or a communication path from the UE 12 toward the base station 11. In the downlink, a transmitter may be a part of the base station 11, and a receiver may be a part of the UE 12. In the uplink, a transmitter is a part of the UE 12, and a receiver may be a part of the base station 11. There are no limits to multiple access schemes in the wireless communication system 10. Code division multiple access (CDMA), time division multiple access (TDMA), frequency division multiple access (FDMA), orthogonal frequency division multiple access (OFDMA), single Carrier-FDMA (SC-FDMA), OFDM-FDMA, OFDM-TDMA, OFDM-CDMA, and the like various multiple access schemes may be used. These modulation schemes increase the capacity of a communication system by demodulating signals received from multiple users of the communication system. Uplink transmission and downlink transmission may use a time division duplex (TDD) technique where different time slots are used for transmission, or a frequency division duplex (FDD) technique where different frequencies are used for transmission.

Layers of a radio interface protocol between the UE and the base station may be divided into a first layer L1, a second layer L2 and a third layer L3 based on three sub layers of an open system interconnection (OSI) model well-known in communication systems. Among them, a physical layer, which belongs to the first layer, provides an information transfer service through a physical channel.

There are some physical channels used in the physical layer. A physical downlink control channel (PDCCH) may carry a resource allocation and a transfer format of a downlink shared channel (DL-SCH), resource allocation information of an uplink shared channel (UL-SCH), a resource allocation of a higher layer control message such as a random access response transmitted to a physical downlink shared channel (PDSCH), a command set of transmission power control (TPC) for each individual UE in a certain UE group, and so on. A plurality of PDCCHs may be transmitted in a control domain, and the UE may monitor the plurality of PDCCHs.

Control information about the physical layer mapped to the PDCCH is called downlink control information (DCI). That is, the DCI is transmitted through the PDCCH. The DCI may include an uplink or downlink resource allocation field, an uplink transmission power control command field, a control field for paging, a control field for indicating a random access (RA) response, etc.

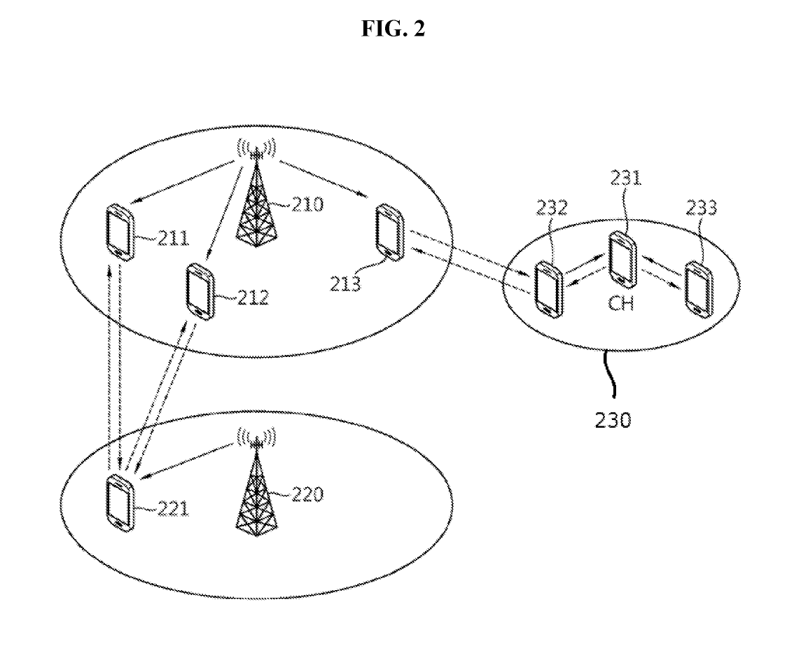

FIG. 2 is a view for explaining the concept of cellular network-based D2D communication.

Referring to FIG. 2, a cellular communication network includes a first base station 210, a second base station 220 and a first cluster 230.

In this case, first UE 211 and second UE 212, which belong to a cell generated by the first base station 210, perform communication through a typical connection link (i.e. a cellular link) via the first base station. Meanwhile, the first UE 211 that belongs to the first base station 210 can perform D2D communication with fourth UE 221 that belongs to the second base station 220. The D2D link may be established in between devices having one cell as a serving cell, and between devices having different cells as the serving cells.

Further, UEs 232 and 233 present within the first cluster 230 perform communication in sync with a cluster header 231. Further, third UE 213 that belongs to the first base station 210 can communicate with second UE 232 present within the first cluster 230 via D2D communication.

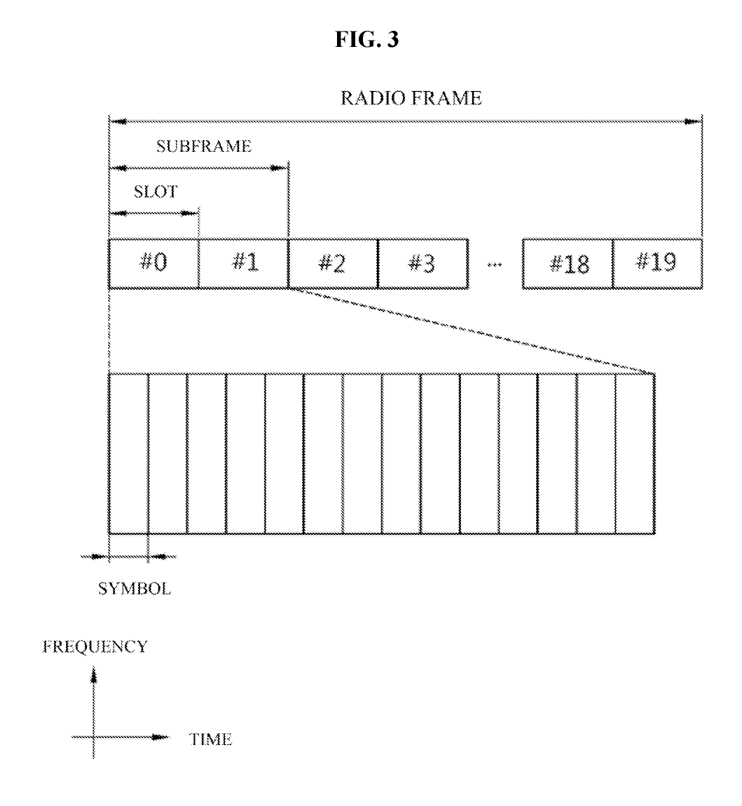

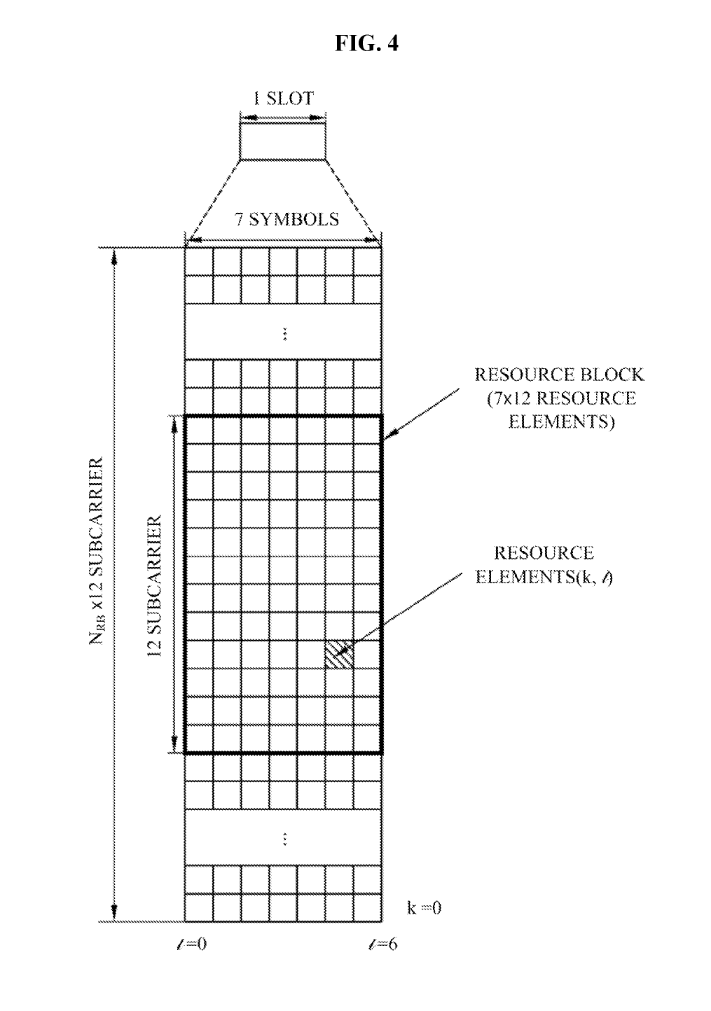

FIG. 3 and FIG. 4 schematically illustrate structures of a radio frame to which the present disclosure is applied.

Referring to FIG. 3 and FIG. 4, a radio frame includes 10 subframes. One subframe includes 2 slots. Time (length) taken for transmitting 1 subframe is called a transmission time interval (TTI). For example, 1 subframe may have a length of 1 ms, and 1 slot has a length of 0.5 ms.

1 slot may include a plurality of symbols in a time domain. For example, the symbol may be an OFDM symbol in a wireless system using OFDMA in the downlink (DL), and may be an SC-FDMA symbol in a wireless system using SC-FDMA in the uplink (UL). Meanwhile, the representations of a symbol period in the time domain are not restricted by the multiple access schemes or names.

The number of symbols included in 1 slot may vary depending on the length of a cyclic prefix (CP). For example, 1 slot may include 7 symbols in case of a normal CP, and may include 6 symbols in case of an extended CP.

A resource element (RE) refers to the smallest time-frequency unit to which a modulation symbol of a data channel, a modulation symbol of a control channel or the like is mapped. A resource block (RB) refers to a resource allocation unit, and includes a time-frequency resource corresponding to 180 kHz on a frequency axis and 1 slot on a time axis. Meanwhile, a resource block pair (PBR) refers to a resource unit including 2 continuous slots on the time axis.

In the wireless communication system, there is a need for estimating an uplink channel or a downlink channel to transmit/receive data, attaining system synchronization, feeding channel information back, and so on. A process of compensating distortion of a signal caused by a rapid change in channel environments and restoring a transmission signal will be called channel estimation. Further, there is a need for measuring a channel state about a cell to which the UE belongs or another cell. In general, a reference signal (RS) known between the UE and a transmitting/receiving point is used to estimate a channel or measure the channel state.

In general, the reference signal is transmitted as a signal generated from a sequence of the reference signal. As the sequence of the reference signal, one or more among various sequences excellent in correlation may be used. For example, a constant amplitude zero auto-correlation (CAZAC) sequence such as a Zadoff-Chu (ZC) sequence, or the like; an m-sequence, a gold sequence, a pseudo-noise (PN) sequence such a Kasami sequence, or the like; etc. may be used as the sequence of the reference signal. In addition, many other sequences excellent in correlation may be used in accordance with system conditions. In addition, the reference signal sequence may be subjected to cyclic extension or truncation to adjust the length of the sequence, and may be modulated in various forms such as binary phase shift keying (BPSK) or quadrature phase shift keying (QPSK) and mapped to resource elements.

Hereinafter, an uplink reference signal will be described.

The uplink reference signal may classified into a demodulation reference signal (DM-RS) and a sounding reference signal (SRS). The DM-RS is a reference signal used for estimating a channel for demodulation of a received signal. The DM-RS may be combined with transmission in a physical uplink shared channel (PUSCH) or a physical uplink shared channel (PUCCH). The SRS is a reference signal that is transmitted to the base station by the UE for uplink scheduling. The base station estimates an uplink channel through the received reference signal, and uses the estimated uplink channel in scheduling the uplink. The SRS is not combined with transmission in the PUSCH or PUCCH. For the DM-RS and SRS, the same kind of primary sequence may be used. Meanwhile, precoding applied to the DM-RS in uplink multiple antenna transmission may be the same as precoding applied to the PUSCH. Cyclic shift separation is a primary scheme for multiplexing the DM-RS. The SRS may be not subjected to the precoding, and may be also an antenna specified reference signal.

The PUSCH DM-RS sequence r^{(λ)}_{PUSCH}(⋅) according to layers λ∈{0, 1, . . . , υ−1} is defined by Expression 1.

r_{PUSCH}^{(λ)}(m·M_{sc}^{RS}+n)=w^{(λ)}(m)r_{u,v}^{(α}^{_{λ}}⁾(n) [Expression 1]

In Expression 1, m=0, 1, and n=0, 1, M_{sc}^{RS}−1. Further, M_{sc}^{RS}=M_{sc}^{PUSCH}. Here, M_{sc}^{RS} is the number of subcarriers for the uplink reference signal, and M_{SC}^{PUSCH} is the number of subcarriers for the PUSCH. An orthogonal sequence w^{(λ)}(m) may be determined by Table 2 to be described below.

The PUSCH DM-RS sequence r^{(λ)}_{PUSCH}(⋅) may be group-hopped by a sequence-group number u, and sequence-hopped by a base sequence number v.

In a slot nₛ, a cyclic shift (CS) is given as α^{λ}=2πn_{cs,λ}/12, and n_{cs} may be defined by Expression 2.

n_{cs,λ}=(n_{DMRS}⁽¹⁾+n_{DMRS,λ}⁽²⁾+n_{PN}(nₛ))mod 12 [Expression 2]

In Expression 2, n⁽¹⁾_{DMRS} may be determined by a cyclic shift (CS) parameter provided in the higher layer. Table 1 shows an example of n⁽¹⁾_{DMRS} determined by the CS parameter.

TABLE 1

| cyclic Shift | n⁽¹⁾_{DMRS} |
|---|---|
| 0 | 0 |
| 1 | 2 |
| 2 | 3 |
| 3 | 4 |
| 4 | 6 |
| 5 | 8 |
| 6 | 9 |
| 7 | 10 |

Referring back to Expression 2, n⁽²⁾_{DMRS,λ} may be determined by a DMRS cyclic shift field in an uplink related DCI format for a transport block according to the corresponding PUSCH transmission. Table 2 shows an example of n⁽²⁾_{DMRS,λ} determined according to the DMRS cyclic shift field.

TABLE 2

| DM-RS | | | | | | | | |
|---|---|---|---|---|---|---|---|---|
| Cycllic | n⁽²⁾_{DMRS, λ} | | | | [w⁽²⁾(0) w⁽²⁾(1)] | | | |
| shift field | λ = 0 | λ = 1 | λ = 2 | λ = 3 | λ = 0 | λ = 1 | λ = 2 | λ = 3 |
| 000 | 0 | 6 | 3 | 9 | [1 1] | [1 1] | [1 −1] | [1 −1] |
| 001 | 6 | 0 | 9 | 3 | [1 −1] | [1 −1] | [1 1] | [1 1] |
| 010 | 3 | 9 | 6 | 0 | [1 −1] | [1 −1] | [1 1] | [1 1] |
| 011 | 4 | 10 | 7 | 1 | [1 1] | [1 1] | [1 1] | [1 1] |
| 100 | 2 | 8 | 5 | 11 | [1 1] | [1 1] | [1 1] | [1 1] |
| 101 | 8 | 2 | 11 | 5 | [1 −1] | [1 −1] | [1 −1] | [1 −1] |
| 110 | 10 | 4 | 1 | 7 | [1 −1] | [1 −1] | [1 −1] | [1 −1] |
| 111 | 9 | 3 | 0 | 6 | [1 1] | [1 1] | [1 −1] | [1 −1] |

n_{PN}(nₛ) may be defined by Expression 3.

n_{PN}(nₛ)=Σᵢ₌₀⁷c(8N_{symb}^{UL}·nₛ+i)·2ⁱ [Expression 3]

c(i) is a binary pseudo random sequence, which may have a value of 0 or 1 with regard to each i. Further, c(i) may be a cell-specific pseudo random sequence. The pseudo random sequence c(i) may be initialized as cᵢₙᵢₜ at a start point of each radio frame. When N_{ID}^{csh}^{_}^{DMRS} is not set from the higher layer or from a PUSCH transmission corresponding to retransmission of a transport block based on a random access procedure or a random access response grant, cₘₐ is as follows.

$${c}_{init} = ⌊ \frac{{N}_{ID}^{cell}}{30} ⌋ \cdot {2}^{5} + ( ( {N}_{ID}^{cell} + {Δ}_{ss} ) mod 30 )$$

otherwise,

$${c}_{init} = ⌊ \frac{{N}_{ID}^{csh \_ DMRS}}{30} ⌋ \cdot {2}^{5} + ( {N}_{ID}^{csh \_ DMRS} mod 30 )$$

The vector of the reference signal is pre-coded by Expression 4.

$$[ \begin{matrix}{\tilde{r}}_{PUSCH}^{( 0 )} \\ ⋮ \\ {\tilde{r}}_{PUSCH}^{( P - 1 )}\end{matrix} ] = W [ \begin{matrix}{r}_{PUSCH}^{( 0 )} \\ ⋮ \\ {r}_{PUSCH}^{( υ - 1 )}\end{matrix} ] \qquad [ Expression 4 ]$$

In Expression 4, P is the number of antenna ports used for the PUSCH transmission. W is a precoding matrix. Regarding the PUSCH transmission using a single antenna port, P=1, W=1, and υ=1. Further, regarding spatial multiplexing, P=2 or 4.

Regarding each antenna port used in the PUSCH transmission, the DM-RS sequence \tilde{r}_{PUSCH}^{(\tilde{p})}(⋅) is multiplied by an amplitude scaling factor β_{PUSCH} and sequentially mapped to the resource block from \tilde{r}_{PUSCH}^{(\tilde{p})}(0). A set of physical resource blocks used in the mapping is the same as the set of physical resource blocks used in the corresponding PUSCH transmission. In the subframe, the DM-RS sequence may be first mapped to the resource element in an increasing direction of the frequency domain, and in an increasing direction of the slot number. The DM-RS sequence may be mapped to the fourth SC-FDMA symbol (index 3) in the normal CP, and may be mapped to the third SC-FDMA symbol (index 2) in the extended CP.

Recently, measures for performing D2D communication between devices outside the network coverage have been researched to meet requirements of public safety or the like. For example, fifth UE 231 may transmit a D2D synchronization signal (D2DSS) as shown in FIG. 2.

Thus, the requirements and coverage for using the D2D communication may be summarized in Table 3 as follows.

TABLE 3

| | Area within network | Area beyond network |
|---|---|---|
| | coverage | coverage |
| Discovery | Non public safety & public | Public safety only |
| | safety requirements | |
| Direct | At least public safety | Public safety only |
| communication | requirements | |

A D2D UE may discover other communication-enabled D2D UEs within or beyond the network coverage. This operation is also called D2D discovery. For the D2D discovery, the D2D UE transmits a discovery signal to other D2D UEs, and other UEs can find the D2D UE on the basis of the discovery signal.

A D2D synchronization source refers to a node for transmitting at least a D2D synchronization signal. The D2D synchronization source transmits at least one D2DSS. The transmitted D2DSS may be used for attaining time-frequency synchronization of the UE. If the D2D synchronization source is the base station (e.g. eNodeB), the D2DSS transmitted from the D2D synchronization source may include the same synchronization signals (SS) as a primary synchronization signal (PSS) and a secondary synchronization signal (SSS).

A sequence d(n) used in the PSS is generated from the frequency domain Zadoff-Chu sequence based on Expression 5.

$${d}_{u} ( n ) = \{ \begin{matrix}{e}^{- j \frac{π un ( n + 1 )}{63}} & n = 0 , 1 , … , 30 \\ {e}^{- j \frac{π u ( n + 1 ) ( n + 2 )}{63}} & n = 31 , 32 , … , 61\end{matrix} \qquad [ Expression 5 ]$$

In Expression 5, u is a root index defined in Table 4.

TABLE 4

| N⁽²⁾ID | Root index |
|---|---|
| 0 | 25 |
| 1 | 29 |
| 2 | 34 |

The sequence d(n) is mapped to the resource element in accordance with Expression 6.

$${a}_{k , l} = d ( n ) , n = 0 , … , 61 \\ k = n - 31 + \frac{{N}_{RB}^{DL} {N}_{sc}^{RB}}{2} \qquad [ Expression 6 ]$$

Here, a_{k,l} is a resource element, in which k is a subcarrier number, and l is an OFDM symbol number.

The mapping between the sequence used in the PSS and the resource element (RE) is determined by a frame structure.

In case of a frame structure type 1 for frequency division duplex (FDD), the PSS is mapped to a slot 0 within one radio frame and the last OFDM symbol within a slot 10.

Meanwhile, in case of a frame structure type 2 for time division duplex (TDD), the PSS is mapped to a subframe 1 within one radio frame and the third OFDM symbol within the subframe 6.

Here, one radio frame includes 10 subframes (from subframe 0 to subframe 9), and corresponds to 20 slots (from slot 0 to slot 19) when one subframe includes 2 slots. Further, one slot includes a plurality of OFDM symbols.

The resource element corresponding to Expression 7 among the resource elements (k, l) within the OFDM symbol is not used for the transmission of the PSS but reserved.

$$k = n - 31 + \frac{{N}_{RB}^{DL} {N}_{sc}^{RB}}{2} \\ n = - 5 , - 4 , … , - 1 , 62 , 63 , … 66 \qquad [ Expression 7 ]$$

Sequences d(0), . . . , d(61) used in the SSS are generated by interleaving two binary sequences of the length 31.

The combination of two binary sequences of the length 31 defining the SSS has different values between the subframe 0 and the subframe 5 in accordance with Expression 8.

$$d ( 2 n ) = \{ \begin{matrix}{s}_{0}^{( {m}_{0} )} ( n ) {c}_{0} ( n ) & in subframe 0 \\ {s}_{1}^{( {m}_{1} )} ( n ) {c}_{0} ( n ) & in subframe 5\end{matrix} \\ d ( 2 n + 1 ) = \{ \begin{matrix}{s}_{1}^{( {m}_{1} )} ( n ) {c}_{1} ( n ) {z}_{1}^{( {m}_{0} )} ( n ) & in subframe 0 \\ {s}_{0}^{( {m}_{0} )} ( n ) {c}_{1} ( n ) {z}_{1}^{( {m}_{1} )} ( n ) & in subframe 5\end{matrix} \qquad [ Expression 8 ]$$

In Expression 8, n has a value satisfying 0≤≤n≤≤30. Values m₀ and m₁ are obtained from physical cell identity group N⁽¹⁾_{ID} according to Expression 9.

$${m}_{0} = {m}^{′} mod 31 \\ {m}_{1} = ( {m}_{0} + ⌊ {m}^{′} / 31 ⌋ + 1 ) mod 31 \\ {m}^{′} = {N}_{ID}^{( 1 )} + q ( q + 1 ) / 2 , \\ q = ⌊ \frac{{N}_{ID}^{( 1 )} + {q}^{′} ( {q}^{′} + 1 ) / 2}{30} ⌋ , {q}^{′} = ⌊ {N}_{ID}^{( 1 )} / 30 ⌋ \qquad [ Expression 9 ]$$

Results from Expression 9 may be expressed as shown in Table 5 and Table 6.

TABLE 5

| N⁽¹⁾_{ID} | m₀ | m₁ |
|---|---|---|
| 0 | 0 | 1 |
| 1 | 1 | 2 |
| 2 | 2 | 3 |
| 3 | 3 | 4 |
| 4 | 4 | 5 |
| 5 | 5 | 6 |
| 6 | 6 | 7 |
| 7 | 7 | 8 |
| 8 | 8 | 9 |
| 9 | 9 | 10 |
| 10 | 10 | 11 |
| 11 | 11 | 12 |
| 12 | 12 | 13 |
| 13 | 13 | 14 |
| 14 | 14 | 15 |
| 15 | 15 | 16 |
| 16 | 16 | 17 |
| 17 | 17 | 18 |
| 18 | 18 | 19 |
| 19 | 19 | 20 |
| 20 | 20 | 21 |
| 21 | 21 | 22 |
| 22 | 22 | 23 |
| 23 | 23 | 24 |
| 24 | 24 | 25 |
| 25 | 25 | 26 |
| 26 | 26 | 27 |
| 27 | 27 | 28 |
| 28 | 28 | 29 |
| 34 | 4 | 6 |
| 35 | 5 | 7 |
| 36 | 6 | 8 |
| 37 | 7 | 9 |
| 38 | 8 | 10 |
| 39 | 9 | 11 |
| 40 | 10 | 12 |
| 41 | 11 | 13 |
| 42 | 12 | 14 |
| 43 | 13 | 15 |
| 44 | 14 | 16 |
| 45 | 15 | 17 |
| 46 | 16 | 18 |
| 47 | 17 | 19 |
| 48 | 18 | 20 |
| 49 | 19 | 21 |
| 50 | 20 | 22 |
| 51 | 21 | 23 |
| 52 | 22 | 24 |
| 53 | 23 | 25 |
| 54 | 24 | 26 |
| 55 | 25 | 27 |
| 56 | 26 | 28 |
| 57 | 27 | 29 |
| 58 | 28 | 30 |
| 59 | 0 | 3 |
| 60 | 1 | 4 |
| 61 | 2 | 5 |
| 62 | 3 | 6 |
| 68 | 9 | 12 |
| 69 | 10 | 13 |
| 70 | 11 | 14 |
| 71 | 12 | 15 |
| 72 | 13 | 16 |
| 73 | 14 | 17 |
| 74 | 15 | 18 |
| 75 | 16 | 19 |
| 76 | 17 | 20 |
| 77 | 18 | 21 |
| 78 | 19 | 22 |
| 79 | 20 | 23 |
| 80 | 21 | 24 |
| 81 | 22 | 25 |
| 82 | 23 | 26 |
| 83 | 24 | 27 |
| 84 | 25 | 28 |
| 85 | 26 | 29 |
| 86 | 27 | 30 |
| 87 | 0 | 4 |
| 88 | 1 | 5 |
| 89 | 2 | 6 |
| 90 | 3 | 7 |
| 91 | 4 | 8 |
| 92 | 5 | 9 |
| 93 | 6 | 10 |
| 94 | 7 | 11 |
| 95 | 8 | 12 |
| 96 | 9 | 13 |

TABLE 6

| N⁽¹⁾_{ID} | m₀ | m₁ |
|---|---|---|
| 102 | 15 | 19 |
| 103 | 16 | 20 |
| 104 | 17 | 21 |
| 105 | 18 | 22 |
| 106 | 19 | 23 |
| 107 | 20 | 24 |
| 108 | 21 | 25 |
| 109 | 22 | 26 |
| 110 | 23 | 27 |
| 111 | 24 | 28 |
| 112 | 25 | 29 |
| 113 | 26 | 30 |
| 114 | 0 | 5 |
| 115 | 1 | 6 |
| 116 | 2 | 7 |
| 117 | 3 | 8 |
| 118 | 4 | 9 |
| 119 | 5 | 10 |
| 120 | 6 | 11 |
| 121 | 7 | 12 |
| 122 | 8 | 13 |
| 123 | 9 | 14 |
| 124 | 10 | 15 |
| 125 | 11 | 16 |
| 126 | 12 | 17 |
| 127 | 13 | 18 |
| 128 | 14 | 19 |
| 129 | 15 | 20 |
| 130 | 16 | 21 |
| 136 | 22 | 27 |
| 137 | 23 | 28 |
| 138 | 24 | 29 |
| 139 | 25 | 30 |
| 140 | 0 | 6 |
| 141 | 1 | 7 |
| 142 | 2 | 8 |
| 143 | 3 | 9 |
| 144 | 4 | 10 |
| 145 | 5 | 11 |
| 146 | 6 | 12 |
| 147 | 7 | 13 |
| 148 | 8 | 14 |
| 149 | 9 | 15 |
| 150 | 10 | 16 |
| 151 | 11 | 17 |
| 152 | 12 | 18 |
| 153 | 13 | 19 |
| 154 | 14 | 20 |
| 155 | 15 | 21 |
| 156 | 16 | 22 |
| 157 | 17 | 23 |
| 158 | 18 | 24 |
| 159 | 19 | 25 |
| 160 | 20 | 26 |
| 161 | 21 | 27 |
| 162 | 22 | 28 |
| 163 | 23 | 29 |
| 164 | 24 | 30 |

Two sequences s₀^{(m}^{₀}⁾(n) and s₁^{(m}^{₁}⁾(n) are defined by two different cyclic shifts of m-sequence \tilde{s}(n) in accordance with Expression 10.

s₀^{(m}^{₀}⁾(n)=\tilde{s}((n+m₀)mod 31)

s₁^{(m}^{₁}⁾(n)=\tilde{s}((n+m₁)mod 31) [Expression 10]

Expression 10 satisfies \tilde{s}(i)=1−2x(i) and 0≤i≤30, and x(i) is defined by Expression 11.

x(ī+5)=(x(ī+2)+x(ī))mod 2,0≤ī≤25 [Expression 11]

In Expression 11, initial values of x(i) are set as x(0)=0, x(1)=0, x(2)=0, x(3)=0, and x(4)=1.

Two scrambling sequences c₀(n) and c₁(n) are defined by the PSS, and m-sequence \tilde{c}(n) according to Expression 12 is defined by two different cyclic shifts.

c₀(n)=\tilde{c}((n+N_{ID}⁽²⁾)mod 31)

c₁(n)=\tilde{c}((n+N_{ID}⁽²⁾=30)mod 31) [Expression 12]

In Expression 12, N⁽²⁾_{ID}∈{0,1,2} is physical layer ID within the physical layer cell ID group N⁽¹⁾_{ID}. Expression 12 satisfies \tilde{c}(i)=1−2x(i) and 0≤i≤30, and x(i) is defined by Expression 13.

x(ī+5)=(x(ī+3)+x(ī))mod 2,0≤ī≤25 [Expression 13]

In Expression 13, initial values of x(i) are set as x(0)=0, x(1)=0, x(2)=0, x(3)=0, and x(4)=1.

The scrambling sequences z₁^{(m}^{₀}⁾(n) and z₁^{(m}^{₁}⁾(n) are defined by the cyclic shift of the m-sequence \tilde{z}(n) according to Expression 14.

z₁^{(m}^{₀}⁾(n)=\tilde{z}((n+(m₀ mod 8))mod 31)

z₁^{(m}^{₁}⁾(n)=\tilde{z}((n+(m₁ mod 8))mod 31)[Expression 14]

In Expression 14, values of m₀ and m₁ are obtained by Table 5 or Table 6, and satisfy \tilde{z}(i)=1−2x(i) and 0≤i≤30. Here, x(i) is defined by Expression 15.

x(ī+5)=(x(ī+4)+x(ī+2)+x(ī+1)+x(ī))mod 2,0≤ī≤25 [Expression 15]

In Expression 15, initial conditions of x(i) are set as x(0)=0, x(1)=0, x(2)=0, x(3)=0, and x(4)=1.

The mapping between the sequence used in the SSS and the resource element (RE) is determined by the frame structure.

The sequence d(n) will be mapped to the resource element according to Expression 16.

$${a}_{k , l} = d ( n ) , n = 0 , … , 61 \\ k = n - 31 + \frac{{N}_{RB}^{DL} {N}_{sc}^{RB}}{2} \\ l = \{ \begin{matrix}{N}_{symb}^{DL} - 2 & \begin{matrix}in slots 0 and 10 for framestructure \\ type 1 \end{matrix} \\ {N}_{symb}^{DL} - 1 & \begin{matrix}in slots 1 and 11 for framestructure \\ type 2\end{matrix}\end{matrix} \qquad [ Expression 16 ]$$

In Expression 16, a_{k,l} is a resource element, in which k is a subcarrier number, and l is an OFDM symbol number.

The resource element corresponding to Expression 17 among the resource elements (k, l) within the OFDM symbol is not used for the transmission of the SSS but reserved.

$$k = n - 31 + \frac{{N}_{RB}^{DL} {N}_{sc}^{RB}}{2} \\ l = \{ \begin{matrix}{N}_{symb}^{DL} - 2 & \begin{matrix}in slots 0 and 10 for frame structure \\ type 1\end{matrix} \\ {N}_{symb}^{DL} - 1 & \begin{matrix}in slots 1 and 11 for frame structure \\ type 2\end{matrix}\end{matrix} \\ vn = - 5 , - 4 , … , - 1 , 62 , 63 , … 66 \qquad [ Expression 17 ]$$

The D2D communication is for providing proximity services between UEs, and will be thus called proximity based services (ProSe). Further, the D2D communication from transmitter D2D UE (Tx D2D UE) to receiver D2D UE (Rx D2D UE) may be called a sidelink for distinguishing from the existing uplink or downlink.

Meanwhile, the D2D synchronization signal transmitted from the transmitter D2D UE to the receiver D2D UE, i.e. the D2DSS, may be called a sidelink synchronization signal (SLSS) to mean the synchronization signal in the sidelink. The SLSS is generated based on a physical layer sidelink synchronization identity (PSSID). The PSSID may be represented as N^{SL}_{ID}, in which N^{SL}_{ID}∈{0, 1, . . . , 335}, and is divided into two sets. One set is id_net having a range of {0, 1, . . . , 167}, and the other set is id_oon having a range of {168, 169, . . . , 335}. id_net is the PSSID that D2DSS sequences of D2DSSue_net can have when the sequences are generated, and id_oon is the PSSID that D2DSS sequences of D2DSSue_oon can have when the sequences are generated. D2DSSue_net refers to a set of D2DSS sequences transmitted from the UE in which a transmission timing reference is eNodeB, and D2DSSue_oon refers to a set of D2DSS sequences transmitted from the UE in which the transmission timing reference is not eNodeB.

Regarding the sidelink, there are a physical sidelink shared channel (PSSCH), a physical sidelink broadcast channel (PSBCH), a physical sidelink control channel (PSCCH), and a physical sidelink discovery channel (PSDCH). In the sidelink, a DM-RS may be transmitted in connection with transmission of the PSSCH, the PSBCH, the PSCCH and the PSDCH, and may be configured similar to the DM-RS related to the PUSCH of the uplink except for some features. For example, the DM-RS transmitted in connection with the PSBCH is similar to the foregoing DM-RS related to the PUSCH of the uplink, except that some parameters used for generating the DM-RS are differently defined as mentioned below in Table 7.

TABLE 7

| Parameter | PSBCH |
|---|---|
| Group Hopping | f_{gh} (nₛ): disabled |
| | fₛₛ = └N_{ID}^{SL}/16┘ mod30 |
| Sequence Hopping | disabled |
| Cyclic Shift | └N_{ID}^{SL}/2┘mod8 |
| Orthogonal Sequence | [+1 +1] if N_{ID}^{SL} mod2 = 0 |
| | [+1 −1] if N_{ID}^{SL} mod2 = 1 |
| Reference signal length | M_{sc}^{PSBCH} |
| Number of layer | 1 |
| Number of antenna ports | 1 |

In the DM-RS related to the PUSCH of the uplink, the group hopping is defined by a sequence-group number u as shown in Expression 18.

u=(f_{gh}(nₛ)+fₛₛ)mod 30 [Expression 18]

In Expression 18, f_{gh}(ns) in the DM-RS related to the PUSCH of the uplink is 0 only when the group hopping is disabled. On the other hand, f_{gh}(ns) in the DM-RS associated with the PSBCH of the sidelink is always 0 since the group hopping is always disabled as shown in Table 7.

In Expression 18, a value of fss in the DM-RS related to the PUSCH of the uplink is determined by Δss configured by the higher layer and the uplink reference signal IDn^{RS}_{ID}. On the other hand, a value of fₛₛ in the DM-RS associated with the PSBCH of the sidelink is determined by PSSID N^{SL}_{ID} as shown in Table 7.

In case of the DM-RS related to the PUSCH of the uplink, the sequence hopping is defined by a base sequence number v.

In case of the DM-RS related to the PUSCH of the uplink, the value of v is 0 only when the group hopping is enabled or the sequence hopping is disabled. On the other hand, the value of v in the DM-RS associated with the PSBCH of the sidelink is always 0 since sequence hopping is disabled as shown in Table 7.

Further, in the DM-RS associated with the PSBCH of the sidelink as shown in Table 7, the cyclic shift and the orthogonal sequence are determined by the PSSID N^{SL}_{ID} unlike those of the DM-RS related to the PUSCH of the uplink

Further, in the DM-RS associated with the PSBCH of the sidelink as shown in Table 7, the reference signal length is equal to the number of subcarriers M_{sc}^{PSBCH} for the PSBCH, the number of layers is 1, and the number of antenna ports is 1.

Meanwhile, the PSBCH includes a D2D system frame number of 14 bits, a TTD UL-DL configuration of 3 bits, an in-coverage indicator of 1 bit, a sidelink system bandwidth of 3 bits, and a reserved field signaled or preconfigured as an SIB. The DFN includes a counter of 10 bits, and an offset of 4 bits. The TDD UL-DL configuration is a value set to 000 in FDD, used for only decoding the PSBCH, and does not include any other characteristics of the UE. The UE may predict priority in a duplex mode of a carrier through the TDD UL-DL configuration. Further, the reserved field is a signaled or preconfigured value having 19 bits, but is not limited thereto.

The transmission of the PSBCH may be performed in the same subframe as the subframe through which the SLSS is transmitted, and the SLSS may have a period of 40 ms. In this case, the subframe for the SLSS and the PSBCH includes two symbols of a primary SLSS, and two symbols of a secondary SLSS. In addition, two symbols may be used for the transmission of the DM-RS associated with the PSBCH. The other symbols may be used for the transmission of the PSBCH.

The primary SLSS has the same basic structure as the PSS. However, the SLSS is transmitted via two adjacent symbols in the transmitted subframe whereas the PSS is transmitted via one symbol in a specific subframe for the transmission of the PSS. The SLSS have a root index u as 26 when the PSSID belongs to id_net and 37 and have a root index u as 37 when the PSSID belongs to id_oon, whereas the PSS have the root index u as 25, 29 or 34.

Further, the secondary SLSS has the same basic structure as the SSS except that the SLSS is transmitted via two adjacent symbols in the transmitted subframe whereas the SSS is transmitted via one symbol in a specific subframe for the transmission of the SSS, and the sequence is generated based on not physical cell identity (PCID) but the PSSID.

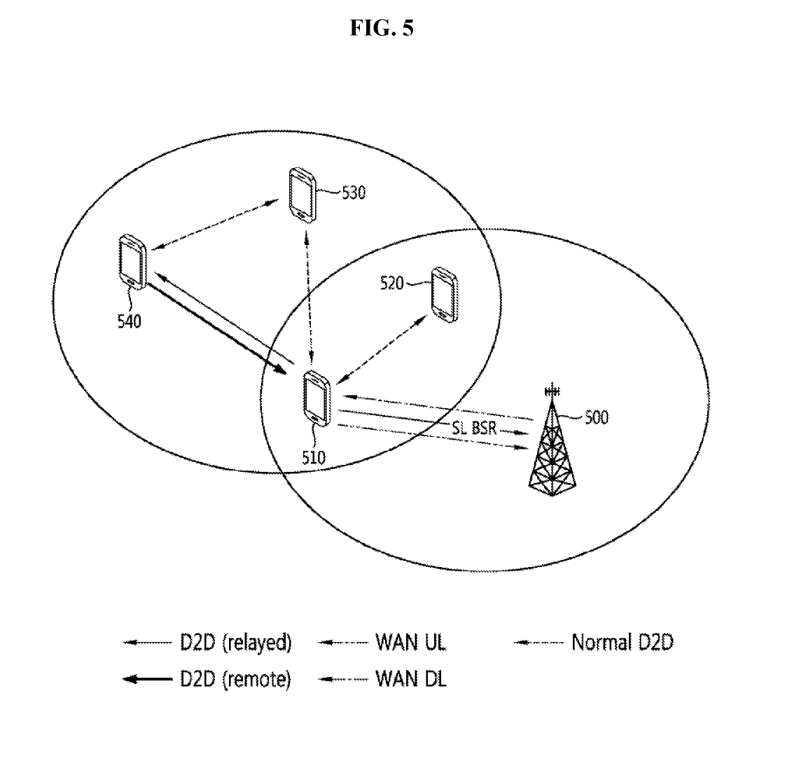

FIG. 5 is a view for explaining a method of expanding network coverage through relay UE in cellular network-based D2D communication.

Referring to FIG. 5, communication between a first UE 510 and a second UE 520 may be D2D communication within the network coverage. Communication between a third UE 530 and a fourth UE 540 may be D2D communication beyond the network coverage. The communication between the first UE 510 and the third UE 530 and the communication between the first UE 510 and the fourth UE 540 may be D2D communication between the UE present inside the network coverage and the UE present outside the network coverage.

A base station 500 may schedule resources needed for UEs 510 and 520 present inside the coverage to transmit data through the sidelink for D2D communication in wireless communication systems. In this case, the UEs 510 and 520 present inside the coverage may use a buffer state report (BSR) to inform the base station 500 how much data to be transmitted through the sidelink (i.e. D2D data) is in a buffer of each UE. The BSR for the sidelink may be called a sidelink (SL) BSR or a proximity service (ProSe) BSR to distinguish from a BSR for a wide area network (WAN).

As one of the embodiments for implementing D2D communication, the base station 500 may transmit D2D resource allocation information to the first UE 510 present inside the coverage of the base station 500. The D2D resource allocation information may include allocation information about the transmitter resources and/or the receiver resources usable for the D2D communication between the first UE 510 and other UEs 520, 530 and 540. The first UE 510 that receives the D2D resource allocation information from the base station may transmit the D2D resource allocation information to other UEs 520, 530 and 540, to which the D2D data will be transmitted, so that other UEs 520, 530 and 540 can receive the D2D data from the first UE 510.

The first UE 510 can implement the D2D communication with the second UE 520, the third UE 530, and/or the fourth UE 540 on the basis of the D2D resource allocation information. Specifically, the second UE 520, the third UE 530 and/or the fourth UE 540 can obtain information about the D2D communication resources of the first UE 510. The second UE 520, the third UE 530 and/or the fourth UE 540 may receive the D2D data from the first UE 510 through the resources indicated by the information about the D2D communication resources of the first UE 510. In this case, the first UE 510 may transmit information about how much D2D data is in the buffer of the first UE 510 to the base station 500 through the SL BSR, so that the resources for the D2D communication with the second UE 520, the third UE 530 and/or the fourth UE 540 can be allocated by the base station 500.

The first UE 510 and the second UE 520 can communicate with the base station 500 since they are present inside the network coverage. That is, the first UE 510 and the second UE 520 can perform UL data transmission and DL data reception with regard to the WAN through the base station 500. On the other hand, the third UE 530 and the fourth UE 540 present outside the network coverage cannot directly communicate with the base station 500. The UE cannot communicate with another UE, a base station, and a server which are present in an area where no signal can physically arrive. However, if the first UE 510 is capable of serving as a relay in case where the fourth UE 540 present outside the network coverage needs to connect with the network for reasons of public safety service, commercial service, etc. and is capable of D2D communication with the first UE 510 present within the network service coverage through the D2D communication, the fourth UE 540 present outside the network coverage can exchange data with the base station 500 through an indirect path. That is, when the first UE 510 serves as the relay UE to receive WAN data, which is desired to be transmitted to the fourth UE 540 by the base station 500, through the downlink, transmit the WAN data to the fourth UE 540 through the D2D communication, receive data, which is desired to be transmitted to the base station 500 by the fourth UE 540, through the D2D communication, and transmit the data to the base station 500 through the uplink, the third UE 530 can communicate with the base station 500. Hereinafter, the UE, which is present inside the network coverage and relays communication between another UE and the base station, will be called the relay UE, and the UE, which is present outside the network coverage and communicates with the base station through the relay UE, will be called remote UE.

In general, in order for the UE to serve as the relay UE, that is, in order to transmit or receive requested data between the remote UE and the base station, there is a need for configuring a radio resource control (RRC) connected state to the base station within the coverage of the base station. However, when the relay UE in an RRC idle mode receives the data requested to be transmitted to the base station from the remote UE, the relay UE starts an RRC connection configuration process for transmitting the data to the base station to enter an RRC connection mode, transmits the data to the base station, and returns to the RRC idle mode by the base station after completing the transmission. Further, when a connection configuration between the relay UE and at least one remote UE is completed by an application layer (higher than an RRC layer but not a wireless layer for the connection configuration) during the RRC idle mode of the relay UE, the relay UE starts the RRC connection configuration process to enter the RRC connection mode and transmit potential relay data to the base station or the remote UE. If no remote UEs to be connected are configured by the application layer, the RRC idle mode is started by the base station. Therefore, the UE serving as the relay UE may maintain the configuration of the relay UE regardless of the RRC connected state even though the RRC connection mode is required for an actual relay operation.

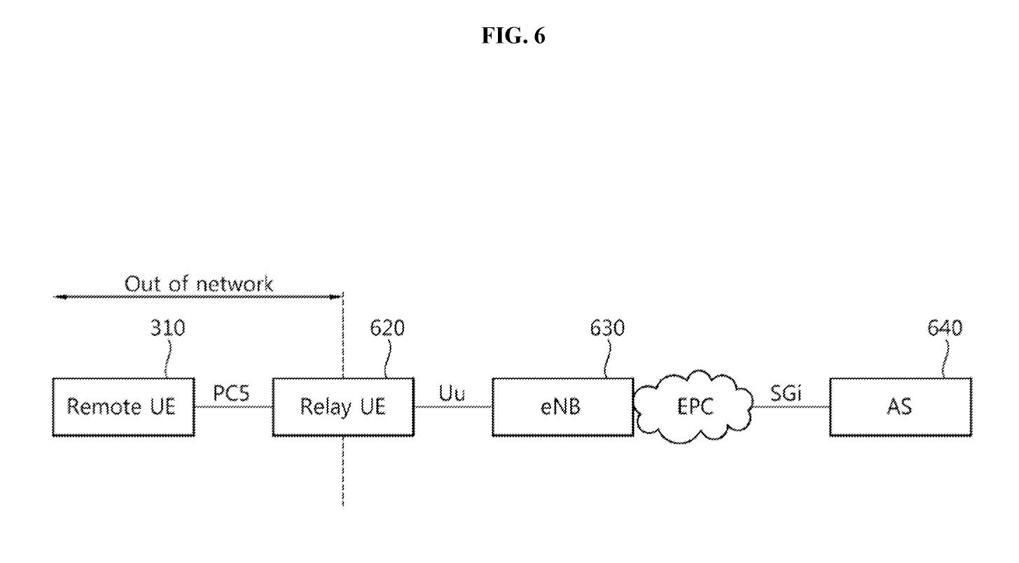

FIG. 6 is a view for explaining a wireless protocol defined in the present disclosure.

In FIG. 6, the interface PC5 between a remote UE 610 present outside the network coverage and a relay UE 620 present inside the network coverage may be defined as a wireless protocol interface of the sidelink. The interface Uu refers to a protocol interface defined in a wireless link between the relay UE 620 and a base station 630. The base station 630 is connected to an evolved packet core (EPC) through an interface S1. The EPC may be connected to an application server (AS) 640 for public safety through an interface SGi.

Below, a method of selecting the relay UE so that the remote UE present outside the coverage of the base station can communicate with the base station will be described.

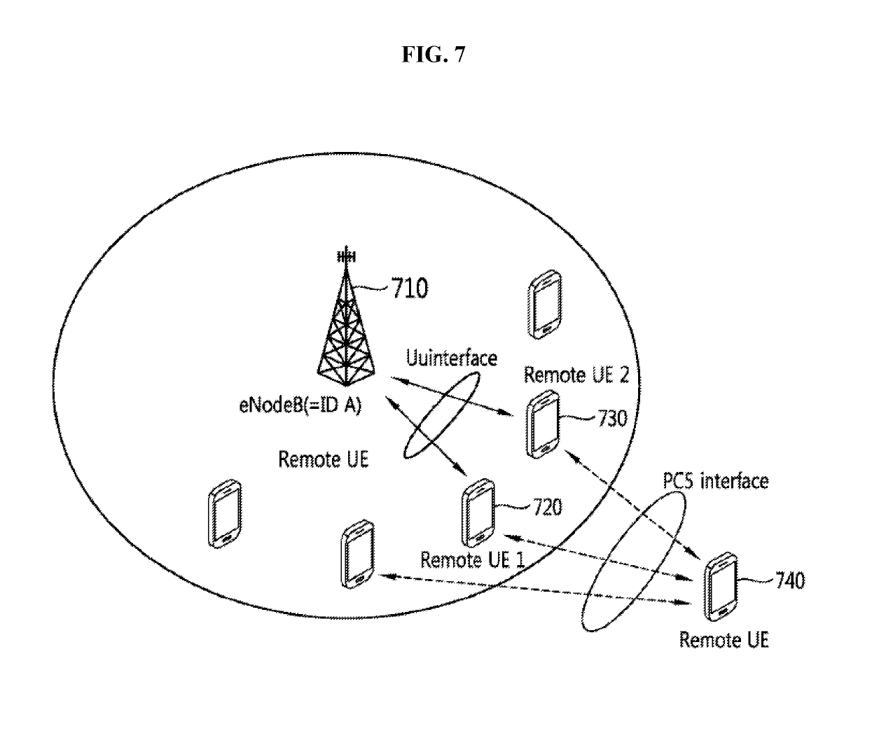

FIG. 7 is a view for explaining a method of selecting the relay UE in the cellular network-based D2D communication according to the present disclosure.

Referring to FIG. 7, a base station (or eNodeB) 710) can select one or more UEs 720 and 730 among D2D communication-enabled UEs, which belong to the base station, as a relay UE(s). A method of selecting the relay UE(s) by the base station 710 may be determined based on metrics about a link between the base station and the D2D UE. The metrics may be, for example, reference signal received power (RSRP) or reference signal received quality (RSRQ).

For example, the base station transmits a synchronization signal such as a PSS or an SSS, or a reference signal such as a cell-specific reference signal (CRS), a demodulation reference signal (DM-RS), or a channel state information reference signal (CSI-RS) to the D2D communication-enabled UEs within the network coverage of the base station. After receiving such a signal, the D2D UE performs measurement with regard to the link between the base station and the UE, and feeds a result of the measurement back to the base station. The base station selects one or more relay UE(s) 720 and 730 based on the result of the measurement received from the D2D UEs. Further, a remote UE 740 present beyond the network coverage of the base station may select one of the selected one or more relay UEs 720 and 730 as the relay UE for communication with the remote UE 740.

Meanwhile, since in-coverage UEs within network coverage of a specific base station are all synchronized with the base station to which they belong, the same sidelink synchronization signal (SLSS) is transmitted based on the same physical-layer sidelink synchronization identity (PSSID), and therefore the DM-RSs generated in connection with the PSBCH according to Table 7 are the same. Accordingly, it is difficult, from the remote UE's viewpoint, to select the relay UE since the same SLSS and the same DM-RS related to the PSBCH are received when surrounding D2D UEs are synchronized with the same base station.

Therefore, according to the present disclosure, there is provided a method for allowing the remote UE to efficiently select a relay UE. This method is based on methods according to the first and second embodiments. In the first and second embodiments, the D2D UEs provide different SLSSs and different DM-RS related to the PSBCH, and thus the remote UE measures the link between the relay UE and the remote UE on the basis of the different signals and selects the relay UE based on the measurement.

### First Embodiment: Determination of PSSID Based on Relay ID

In this embodiment, the PSSID may be determined based on the relay ID, and the relay UE for communication with the remote UE may be selected using one or both of the SLSS and the PSBCH.

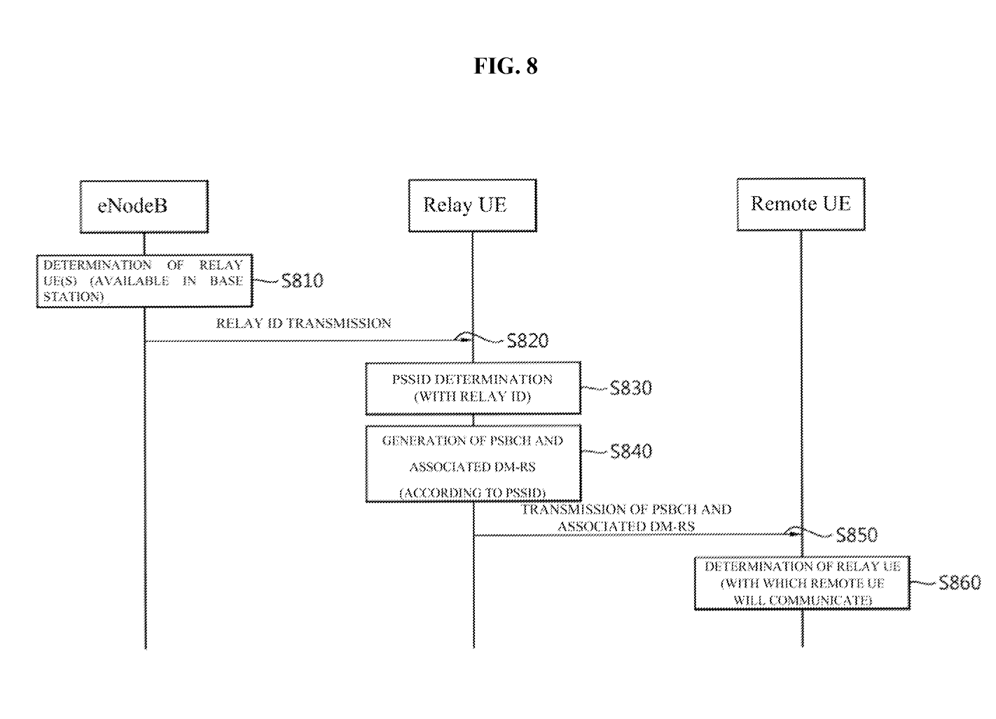

FIG. 8 illustrates a flow of the method for selecting a relay UE to communicate with a remote UE according to one embodiment of the present disclosure.

Referring to FIG. 8, the base station selects one or more UEs as the relay UE(s) among the D2D communication-enabled UEs within the network coverage of the base station (S810). In this case, the relay UE(s) may be selected by metrics about the link between the base station and the D2D communication-enabled UE. For example, when a value obtained by measuring the RSRP or RSRQ received from the in-coverage D2D UEs of the base station exceeds a threshold, these UE may be selected as a relay UE. In more detail, the base station transmits the synchronization signal such as the PSS or the SSS, or the reference signal such as the CRS, the DM-RS or the CSI-RS to all in-coverage D2D UEs of the base station, and the UE receiving such a signal performs measurement with regard to the link between the base station and the UE. After performing the measurement, each of the UEs feeds results of the measurement back to the base station, and the base station compares the result of the measurement with the threshold and selects the UE, the result of which exceeds the threshold, as the relay UE. One or more UEs may be selected as the relay UE.

Next, the base station transmits the relay ID to all selected relay UE(s) (S820). The relay ID may have a value between 1 and N−1. The relay ID may have a value for classifying and changing the PSSID, which belongs to id_net, according to the relay UEs. To transmit the relay ID, resources of log₂N bits are needed. For example, if N=8, resources of 3 bits are needed. If N=16, resources of 4 bits are needed. Further, N may be set to support more UEs, for example, resources of 5 bits (classification into 32 UEs) or resources of N bits (classification into 2^{N} UEs).

For example, N^{SL}_{ID} may be set to be different among the base stations, so that the UEs synchronized with one base station can have the same N^{SL}_{ID}. In this case, the UEs synchronized with one base station are different in relay ID, thereby identifying the UEs having the same synchronization from one another. That is, the same PSSID is allocated to the UEs synchronized with the same base station, and offsets are allocated to the UEs so as to identify the UEs.

In more detail, one of the PSSIDs {0, 1, . . . , 167} is equally allocated to the UEs synchronized with the same base station, and one of the offsets (0, 1, . . . 7 or 0, 1, . . . 15) for identifying the UEs is selected and transmitted to set the relay ID differently. In this case, regarding the transmission of the relay ID, the base station may additionally transmit a part or the entirety of the PCID of the base station, i.e. source information about a synchronization signal, to the relay UE. Further, the PCID of the base station may have been already recognized in the operation S820 without separate signaling since the relay UE is the UE present within the coverage of the base station. The relay ID may be transmitted by higher layer signaling such as radio resource control (RRC) or the like. In the example shown in FIG. 7, the base station may transmit the relay ID to the first and second UEs.

Next, the UEs, which receive the relay ID, determine the PSSID on the basis of the received relay ID (S830). In accordance with the relay ID, the UEs that receive the relay ID change and determine (reconfigure) the PSSID that belongs to id_net.

In this embodiment, the PSSID may be represented by N^{SL}_{ID}_{_}_{new}, and calculated by Expression 19.

N_{ID}_{_}_{new}^{SL}=(N_{ID}^{SL}+relay ID)mod 168 [Expression 19]

In Expression 19, N^{SL}_{ID} has a value of {0, 1, . . . , 335} as described above. However, according to the present disclosure, N^{SL}_{ID} has a value of {0, 1, . . . , 167} as the PSSID that belongs to id_net since the relay UE(s) are present inside the network coverage of the base station. Further, the relay ID in Expression 19 indicates the relay ID received by the relay UE from the base station. Meanwhile, N^{SL}_{ID} has to be scheduled to have different values with regard to UEs synchronized with different base stations. For example, N^{SL}_{ID} is configured to be different according to the base stations, and set as the same value with regard to the UEs synchronized with the same base station. In this case, the relay ID is differently set with regard to different UEs synchronized with the same base station, thereby identifying the different UEs. That is, the same PSSID is allocated to the UEs synchronized with the same base station, and the offsets are allocated for identifying the UEs.

In more detail, the PSSID {0, 1, . . . , 167} equally allocated to the UEs synchronized with the same base station is determined, and the relay ID differently set with one of the offsets (0, 1, . . . 7 or 0, 1, . . . 15) for identifying the UEs is determined. Therefore, the relay ID assigned with the offset value from 0 to 7 or the offset value from 0 to 15 is determined with regard to one value (PSSID) arbitrarily selected within the foregoing range of the PSSID. In connection with the offsets (N), resources of 5 bits (classification into 32 UEs) or resources of N bits (classification into 2^{N} UEs) may be applied to identify more UEs corresponding to the same synchronization source.

In this case, regarding the transmission of the relay ID, a part or the entirety of the PCID of the base station, i.e. source information about the synchronization signal from the base station may be additionally determined. This may be determined through the PCID or PSSID previously grasped by the UE since the UE is present within the cells of the base station, or through the PCID or PSSID transmitted together in the operation S820.

Next, the relay UE generates a PSBCH and a DM-RS related to the PSBCH on the basis of the PSSID determined in the operation S830 (S840).

The PSBCH and the DM-RS associated with the PSBCH may generated by matching N^{SL}_{ID}_{_}_{new} calculated by Expression 19 to N^{SL}_{ID} of Table 7. Referring to Table 7, the PSBCHs and DM-RSs may be differently generated since the relay UEs have different PSSIDs.

Meanwhile, the relay UE may use the reserved bits of the PSBCH to add separate information. Some or all of the PCID complying with the synchronization of the base station, N^{SL}_{ID}, and the relay ID received from the base station may be added using the reserved bits. log₂N bits need to be reserved to add the relay ID, and 8 bits need to be reserved to add N^{SL}_{ID}. Further, 9 bits need to be reserved to add the PCID complying with the synchronization of the base station. When the relay ID is added, the remote UE determines whether the UE for the transmission of the PSBCH is the relay UE or not, based on the foregoing pieces of information, and even determines the base station to which the relay UE for the transmission of the PSBCH belongs and information about the original N^{SL}_{ID} but not the PSSID changed into N^{SL}_{ID}_{_}_{new}. The reserved bit may be transmitted together with the relay ID and the PCID of the base station in the operation S820, or may be the information already grasped as the relay UE is the UE present within the cell of the base station. Therefore, one embodiment of the present disclosure should not be construed as meaning that the reserved bits are always transmitted in the operation S820

Next, the PSBCH and the DM-RS associated with the PSBCH generated in the operation 840 are transmitted to the remote UE (S850).

The remote UE determines the relay UE to communicate with on the basis of the PSBCH and the DM-RS associated with the PSBCH received from the relay UE(s) (S860). In this case, one or more relay UE(s) selected by the base station may be called a potential relay UE(s), and the remote UE determines the relay UE to communicate with among one or more potential relay UE(s) selected by the base station.

Specifically, the remote UE measures sidelink reference signal received power (S-RSRP) from the DM-RS of the PSBCH received from the relay UE. The remote UE compares the relay UEs with respect to the measured S-RSRPs, and determines the relay UE, which has the strongest signal, as the relay UE to communicate with.

Meanwhile, the embodiment of FIG. 8 shows the method for selecting the relay UE to communicate with the remote UE by measuring the S-RSRP based on the DM-RS included in the PSBCH. Alternatively, the relay UE may transmit the sidelink synchronization signal (SLSS) to the remote UE, and the remote UE receiving this may perform the measurement about the like between the relay UE and the remote UE based on the received SLSS, so that the remote UE can select the relay UE to communicate with based on the measurement.

On the other hand, the relay UE may transmit the SLSS and the DM-RS associated with the PSBCH to the remote UE, and the remote UE receiving them may select the relay UE to communicate with based on both the received SLSS and the DM-RS. Specifically, the remote UE performs the measurement about the link between the relay UE and the remote UE on the basis of the received SLSS, and selects the relay UEs, measurement values of which exceed a threshold, as candidate relay UEs to communicate with. The candidate relay UEs are measured with respect to the S-RSRP of the DM-RS associated with the PSBCH, and compared with each other with respect to the measured S-RSRP, so that the candidate relay UE having the strongest signal can be determined as the relay UE for the communication.

### Second Embodiment: Determination of PSSID Based on id_Relay

In this embodiment, the PSSID is determined based on id_relay, and one or both of the SLSS and the PSBCH may be used in selecting the relay UE to communicate with the remote UE.

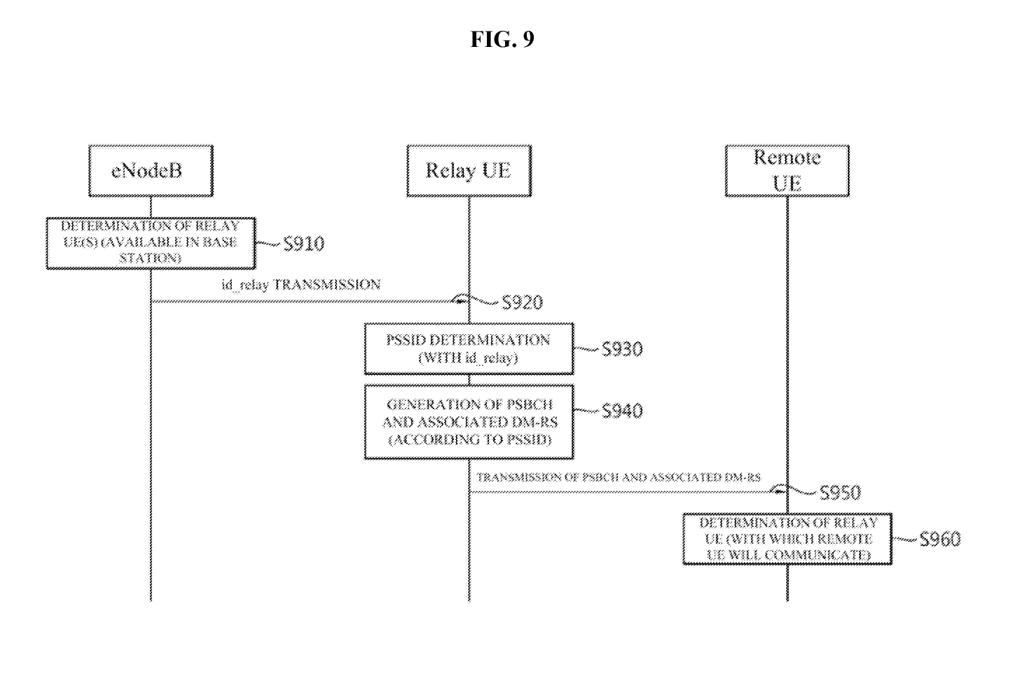

FIG. 9 illustrates a flow of the method for selecting a relay UE to communicate with a remote UE according to another embodiment of the present disclosure.

Referring to FIG. 9, the base station selects one or more UEs among the D2D communication-enabled UEs within the network coverage of the base station as the relay UE(s) (S910). In this case, the relay UE(s) may be selected by metrics about the link between the base station and the D2D communication-enabled UE. For example, if a value obtained by measuring the RSRP or RSRQ received from the in-coverage D2D UEs of the base station exceeds a threshold, these UE may be selected as a relay UE. In more detail, the base station transmits the synchronization signal such as the PSS or the SSS, or the reference signal such as the CRS, the DM-RS or the CSI-RS to all in-coverage D2D UEs of the base station, and the UE receiving such a signal performs measurement with regard to the link between the base station and the UE. After performing the measurement, each of the UEs feeds results of the measurement back to the base station, and the base station compares the result of the measurement with the threshold and selects the UE, the result of which exceeds the threshold, as the relay UE. One or more UEs may be selected as the relay UE.

Next, the base station transmits id_relay to all selected relay UE(s) (S920). id_relay may be defined as a third set of PSSID. That is, the base station transmits PSSID {336, 337, . . . , 503}, which belongs to id_relay, to all selected relay UE(s). As described above, the PSSID can be represented by N^{SL}_{ID}, in which N^{SL}_{ID}∈{0, 1, . . . , 335}, and is divided into two sets. One is id_net having a range of {0, 1, . . . , 167}, and the other one is id_oon having a range of {168, 169, . . . , 335}. Herein, a new set of PSSID is added and defined as id_relay having a range of {336, 337, . . . , 503}. To sum up, three sets of PSSID are as shown in Table 8. In accordance with the sets of PSSID, the root indexes of the primary SLSS may be different. That is, by receiving the SLSS, the D2D UE can determine whether the PSSID belongs to the id_net, the id_oon or the id_relay in accordance with different root indexes. In this case, when the PSSID belongs to id_net, the primary SLSS has a root index u=27. When the PSSID belongs to id_oon, the primary SLSS has a root index u=36. When the PSSID belongs to id_relay, the primary SLSS has a root index u=X. In this case, X may be equal to 38 by way of example, but is not limited thereto. Alternatively, another specific value between 1 and 62 may be given as X.

TABLE 8

| PSS/SSS | SLSS |
|---|---|
| u = 25, PCID = | id_net, u = 27, PSSID = |
| {0, 1, . . . , 167} | {0, 1, . . . , 167} |
| u = 29, PCID = | id_oon, u = 36, PSSID = |
| {168, 169, . . . , 335} | {168, 169, . . . , 335} |
| u = 34, PCID = | id_relay, u = X, PSSID = |
| {336, 337, . . . , 503} | {336, 337, . . . , 503} |

The id_relay may be transmitted by higher layer signaling such as RRC and the like. In the example of FIG. 7, the base station may transmit the id_relay to the first and second UEs.

Next, the UEs, which receive the id_relay, determine the PSSID based on the received id_relay (S930). In this embodiment, the PSSID may use the value of the id_relay received from the base station as it is. That is, the PSSID may be determined as PSSID that belongs to the id_relay received from the base station.

Next, the relay UE generates a PSBCH and a DM-RS associated with the PSBCH on the basis of the PSSID determined in the operation S930 (S940).

The PSBCH and the DM-RS associated with the PSBCH may be generated by matching the id_relay to the N^{SL}_{ID} of Table 7. Referring to Table 7, the PSBCHs and DM-RSs may be differently generated since the relay UEs have different PSSIDs.

Meanwhile, the relay UE may use the reserved bits of the PSBCH to add separate information. The reserved bits may be added with the PCID of the base station complying with the synchronization. To add the PCID of the base station complying with the synchronization, 9 bits need to be reserved. In this case, the remote UE may check an ID of the base station having the network coverage to which the relay UE belongs.

Next, the PSBCH and the DM-RS associated with the PSBCH generated in the operation S940 are transmitted to the remote UE (S950).

The remote UE determines the relay UE to communicate with on the basis of the PSBCH and the DM-RS associated with the PSBCH received from the relay UE(s) (S960). In this case, one or more relay UE(s) selected by the base station may be called a potential relay UE(s), and the remote UE determines the relay UE to communicate with among one or more potential relay UE(s) selected by the base station.

Specifically, the remote UE measures sidelink reference signal received power (S-RSRP) from the DM-RS of the PSBCH received from the relay UE. The remote UE compares the relay UEs with respect to the measured S-RSRPs, and determines the relay UE, which has the strongest signal, as the relay UE to communicate with.

Meanwhile, the embodiment of FIG. 9 shows the method for selecting the relay UE to communicate with the remote UE by measuring the S-RSRP based on the DM-RS included in the PSBCH. Alternatively, the relay UE may transmit the sidelink synchronization signal (SLSS) to the remote UE, and the remote UE receiving this may perform the measurement about the like between the relay UE and the remote UE based on the received SLSS, so that the remote UE can select the relay UE to communicate with based on the measurement.

On the other hand, the relay UE may transmit the SLSS and the DM-RS associated with the PSBCH to the remote UE, and the remote UE receiving them may select the relay UE to communicate with based on both the received SLSS and the DM-RS. Specifically, the remote UE performs the measurement about the link between the relay UE and the remote UE on the basis of the received SLSS, and selects the relay UEs, measurement values of which exceed a threshold, as candidate relay UEs to communicate with. The candidate relay UEs are measured with respect to the S-RSRP of the DM-RS associated with the PSBCH, and compared with each other with respect to the measured S-RSRP, so that the candidate relay UE having the strongest signal can be determined as the relay UE for the communication.

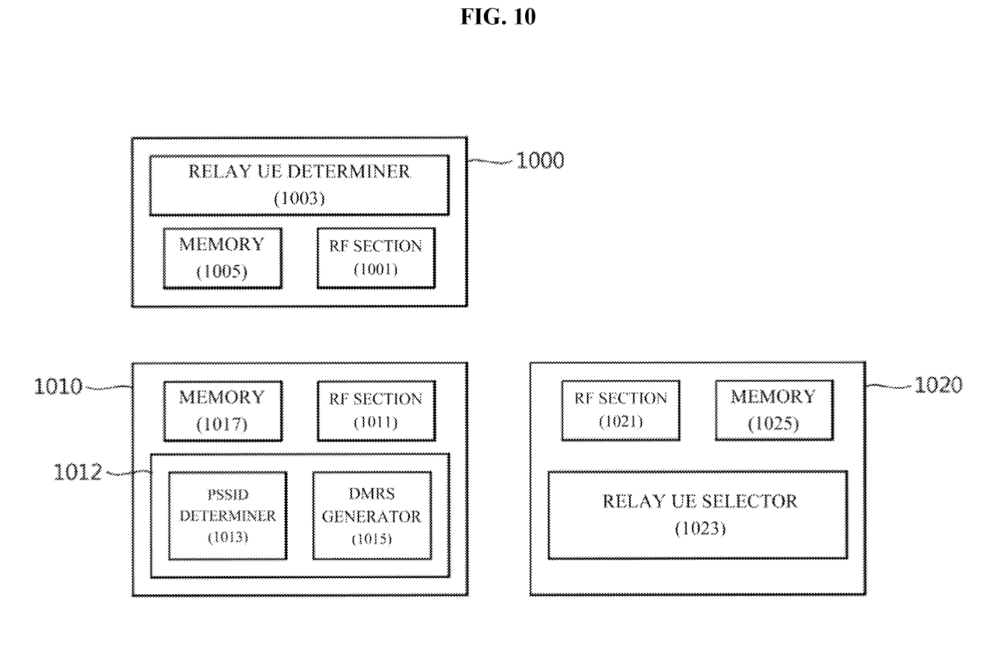

FIG. 10 is a block diagram of a wireless communication system according to one embodiment of the present disclosure.

Referring to FIG. 10, a base station 1000 includes an RF section 1001, a relay UE determiner 1003 and a memory 1005. The memory 1005 is connected to the relay UE determiner 1003, and stores a variety of pieces of information to drive the relay UE determiner 1003. The RF section 1001 is connected to the relay UE determiner 1003, and transmits and/or receives a wireless signal. For example, the RF section 1001 transmits a synchronization signal such as a PSS or an SSS, or a reference signal such as a cell-specific reference signal (CRS), a demodulation reference signal (DM-RS), or a channel state information reference signal (CSI-RS) to all UEs within the base station. Further, the RF section 1001 transmits the relay ID or id_relay to the relay UEs selected by the relay UE determiner 1003.

That is, the relay UE determiner 1003 implements the proposed functions, processes and/or methods.

In addition, the relay UE determiner (or processor) 1003 selects one or more UEs among D2D communication-enabled UEs within the network coverage of the base station as relay UEs. In this case, the relay UEs may be selected by metrics about a link between the base station and the D2D communication-enabled UEs. For example, the relay UE determiner 1003 measures a RSRP or RSRQ received from the in-coverage D2D UEs of the base station, and selects the UE, a measured value of which exceeds a threshold, as the relay UE. As the relay UE, one or more UEs may be selected.

The relay UE determiner 1003 determines the relay ID or id_relay under radio resource control (RRC) according to one embodiment of the present disclosure. The determined relay ID or id_relay may be transmitted by the higher layer signaling. First, the relay ID may have a value between 1 and N−1. The relay ID may have a value for classifying and changing the PSSID, which belongs to id_net, according to the relay UEs. For example, Expression 19 is employed, and N^{SL}_{ID} has a value of {0, 1, . . . , 167} as the PSSID that belongs to id_net. That is, the same PSSID is allocated to the UEs synchronized with the same base station, and the offsets are allocated for identifying the UEs to thereby generate the relay ID. In more detail, the PSSID {0, 1, . . . , 167} is equally allocated to the UEs synchronized with the same base station, and the relay ID is allocated by selecting one of the offsets (0, 1, . . . 7 or 0, 1, . . . 15) for identifying the UEs of the same PSSID. Here, resources of 3 bits (identification of 8 UEs) to N bits (identification of 2^{N} UEs) may be applied to define the offsets in order to identify more UEs corresponding to the same synchronization source.

Further, according to another embodiment of the present disclosure, the relay UE determiner 1003 may define id_relay as a third set of PSSID as shown in Table 8. The PSSID can be represented by N^{SL}_{ID}, in which N^{SL}_{ID}∈{0, 1, . . . , 335}, and is divided into two sets. One is id_net having a range of {0, 1, . . . , 167}, and the other one is id_oon having a range of {168, 169, . . . , 335}. Herein, a new set of PSSID is added and defined as id_relay to have a range of {336, 337, . . . , 503}. In accordance with the sets of PSSID, the root indexes of the primary SLSS may be different. That is, when the PSSID belongs to id_relay, the primary SLSS has a root index u=X. In this case, X may be equal to 38 by way of example, but is not limited thereto. Alternatively, another specific value between 1 and 62 may be defined as X.

A relay UE 1010 includes an RF section 1011, a processor 1012, and a memory 1017. The memory 1017 is connected to a PSSID determiner 1013 and a DM-RS generator 1015, and stores a variety of pieces of information for driving the processor 1012. The RF section 1011 is connected to the processor 1012, and transmits and/or receives a wireless signal. For example, the RF section 1011 receives the relay ID or the id_relay from the base station 1000. Further, the RF section 1011 transmits the DM-RS associated with the PSBCH to the remote UE 1020.

According to one embodiment of the present disclosure, the processor 1012 determines the relay ID or id_relay under the RRC. The determined relay ID or id_relay may be checked through the higher layer signaling.

Therefore, the processor 1012, more specifically, the PSSID determiner 1013 determines the PSSID that belongs to id_net, and checks a value identified and varied depending on the relay UEs. For example, it is determined whether N^{SL}_{ID} has a value of {0, 1, . . . , 167} as the PSSID that belongs to id_net, thereby ascertaining the determined offsets. That is, the same PSSID is allocated to the UEs synchronized with the same base station, and the offsets are allocated for identifying the UEs to thereby generate the relay ID. In more detail, the PSSID {0, 1, . . . , 167} is equally allocated to the UEs synchronized with the same base station, and the relay ID is allocated by selecting one of the offsets (0, 1, . . . 7 or 0, 1, . . . 15) for identifying the UEs of the same PSSID. Here, resources of 3 bits (identification of 8 UEs) to N bits (identification of 2^{N} UEs) may be applied to define the offsets in order to identify more UEs corresponding to the same synchronization source.

Further, according to another embodiment of the present disclosure, the PSSID determiner 1013 may determine whether a third set of PSSID as shown in Table 8 has a range of {336, 337, . . . , 503} as id_relay. In this case, when the PSSID belongs to id_relay, the primary SLSS having a root index u=X is applied to configure id_relay. In this case, X may be equal to 38 by way of example, but is not limited thereto. Alternatively, another specific value between 1 and 62 may be defined as X.

Therefore, the DM-RS generator 1015 checks relay information determined according to the first or second embodiments so as to determine the PSSID, and generates and transmits the PSBCH or DM-RS based on the identity information.

The processor 1012 implements the proposed functions, processes and/or methods. The processor 1012 includes the PSSID determiner 1013 and the DM-RS generator 1015.

The PSSID determiner 1013 determines the PSSID based on the relay ID or id_relay received from the base station. When the PSSID determiner 1013 employs the relay ID to determine the PSSID, the PSSID may be determined by the description in connection with Expression 19. On the other hand, when the PSSID determiner 1013 employs the id_relay to determine the PSSID, the value of id_relay may be directly used as the PSSID.

The DM-RS generator 1015 generates the PSBCH and the DM-RS associated with the PSBCH based on the PSSID determined in the PSSID determiner 1013. The PSBCH and the DM-RS associated with the PSBCH may be generated by matching the PSSID to the N^{SL}_{ID} of Table 7. Referring to Table 7, the PSBCHs and DM-RSs may be differently generated since the relay UEs have different PSSIDs.

Meanwhile, the processor 1012 may embed additional information in the reserved bits of the PSBCH. When the UE receives the relay ID from the base station, some or all of the PCID complying with the synchronization of the base station, N^{SL}_{ID}, and the relay ID received from the base station may be embedded in the reserved bits. On the other hand, when the UE receives the id_relay from the base station, the PCID of the base station may be embedded in the reserved bits. log₂N bits need to be reserved to add the relay ID, and 8 bits need to be reserved to add N^{SL}_{ID}. Further, 9 bits need to be reserved to add the PCID complying with the synchronization of the base station. When the relay ID is added, the remote UE may determine whether or not the UE for the transmission of the PSBCH is the relay UE, based on the foregoing pieces of information, and even determines the base station to which the relay UE for the transmission of the PSBCH belongs and information about original N^{SL}_{ID} but not the PSSID changed into N^{SL}_{ID}_{_}_{new}.

Further, the processor 1012 may generate a sidelink synchronization signal (SLSS).

The remote UE 1020 includes an RF section 1021, a relay UE selector 1023 and a memory 1025. The memory 1025 is connected to the relay UE selector 1023, and stores a variety of pieces of information for driving the relay UE selector 1023. The RF section 1021 is connected to the relay UE selector 1023, and transmits and/or receives a wireless signal. For example, the RF section 1021 receives a PSBCH and a DM-RS from the relay UE. Further, the RF section 1021 transmits information about the relay UE for performing communication to the relay UE 1010.

The relay UE selector 1023 implements the proposed functions, processes and/or methods. The relay UE selector 1023 determines the relay UE for performing the communication based on the PSBCH and the DM-RS associated with the PSBCH received in the RF section 1021. In this case, one or more relay UE(s) selected by the base station may be called a potential relay UE(s), and the remote UE selector 1023 determines the relay UE to communicate with the remote UE 1020 among one or more potential relay UE(s) selected by the base station. Specifically, the relay UE selector 1023 measures sidelink reference signal received power (S-RSRP) from the DM-RS of the PSBCH received from the relay UE. The relay UE selector 1023 compares the relay UEs with respect to the measured S-RSRPs, and determines the relay UE, which has the strongest signal, as the relay UE to communicate with.

Meanwhile, when the SLSS is received from the relay UE, the relay UE selector 1023 performs measurement about a link between the relay UE and the remote UE on the basis of the received SLSS, so that the remote UE can select the relay UE to communicate with on the basis of the measurement.

On the other hand, the relay UE selector 1023 may select the remote UE to perform communication on the basis of both the SLSS and the DM-RS received from the relay UE. Specifically, the relay UE selector 1023 performs the measurement about the link between the relay UE and the remote UE on the basis of the SLSS received from the relay UE, and selects the relay UEs, measurement values of which exceed the threshold, as candidate relay UEs for performing the communication. The candidate relay UEs are measured with respect to the S-RSRP of the DM-RS associated with the PSBCH, and compared with each other with respect to the measured S-RSRP, so that the candidate relay UE having the strongest signal can be determined as the relay UE for the communication.

In the foregoing exemplary apparatuses, the methods are described based on a series of operations or a flowchart with blocks. However, the operations of the present disclosure are not limited to the order described above. For example, certain operations may be implemented in a different order or simultaneously. Further, it will be appreciated by a person having an ordinary skill in the art that the operations shown are not exclusive and one or more other operations may be deleted from or added to the operations shown in the flowchart without affecting the scope of the present disclosure.

According to the present disclosure, it is possible to efficiently configure a relay UE so that a UE outside network coverage can communicate with a base station in D2D communication. Further, it is possible to configure a relay UE so that a UE outside the network coverage can communicate with a base station in D2D communication.

1. A method of configuring a relay between a user equipment (UE) and a network in device-to-device (D2D) communication, the method comprising:
selecting one or more UEs, which support the D2D communication within network coverage of a base station, as relay UEs;
allocating and transmitting a unique number to the UEs selected as the relay UEs;
by the relay UE, determining a physical layer sidelink synchronization identity (PSSID) based on the received unique number;
by the relay UE, generating a physical sidelink broadcast channel (PSBCH) and a demodulation reference signal (DM-RS) associated with the PSBCH based on the PSSID;
by the relay UE, transmitting the generated PSBCH and DM-RS associated with the PSBCH to a remote UE for performing communication with the base station beyond the network coverage; and
by the remote UE, selecting a UE, with which the remote UE itself will communicate, among the relay UEs.

2. (canceled)

3. A method of configuring a relay user equipment (UE) in device-to-device (D2D) communication by a base station, the method comprising:
selecting a relay UE by determining metrics of a signal transmitted from at least one UE, wherein the at least one UE is selected as the relay UE when reference signal received power (RSRP) or reference signal received quality (RSRQ) of the signal transmitted from the at least one UE exceeds a preset threshold; and
transmitting identity information about the selected relay UE, wherein the identity information about the relay UE comprises offset information for identifying the UEs with regard to the same synchronization identity information.

4. The method of claim 3, wherein the selecting of the relay UE comprises: getting feedback on a result of measurement about a synchronization signal or reference signal transmitted from the base station by the at least one UE, and selecting the relay UE by comparing the feedback on the result of the measurement with the threshold,
wherein the synchronization signal comprises at least one of a primary synchronization signal (PSS) and a secondary synchronization signal (SSS),
wherein the reference signal comprises at least one of a cell-specific reference signal (CRS), a demodulation reference signal (DM-RS), and a channel state information reference signal (CSI-RS), and
wherein the synchronization signal or the reference signal is measured with respect to the RSRP or RSRQ.

5. The method of claim 3, wherein the identity information about the relay UE comprises: identity information (PSSID) about the same synchronization signal determined by the base station, and UE identity information of 3 or 4 bit offsets for identifying the relay UE.

6-8. (canceled)

9. A method of configuring a relay user equipment (UE) in device-to-device (D2D) communication by a base station, the method comprising:
selecting a relay UE by determining metrics of a signal transmitted from at least one UE, wherein the at least one UE is selected as the relay UE when reference signal received power (RSRP) or reference signal received quality (RSRQ) of the signal transmitted from the at least one UE exceeds a preset threshold; and
transmitting identity information about the selected relay UE to the relay UE, wherein group information comprising a physical layer sidelink synchronization identity (PSSID) configured for identifying the relay UE is different in value from group information comprising a PSSID of the base station.

10. The method of claim 9, wherein the PSSID configured for identifying the relay UE is differently allocated with a root index of a primary sidelink synchronization signal (SLSS) configured for identifying the relay UE.

11-13. (canceled)
